(19) United States
(12) Patent Application Publication
(10) Pub. No.: US 2009/0018018 A1
(43) Pub. Date: Jan. 15, 2009

(54) HERBICIDAL COMPOSITION COMPRISING AMINOPHOSPHATE OR AMINOPHOSPHONATE POTASSIUM SALT

(75) Inventors: Paul Gioia, Victoria (AU); Poay Huang Chuah, Singapore (SG); Thierry Sclapari, Chatou (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Rhodia Operations, Aubervilliers (FR)

(21) Appl. No.: 12/091,284

(22) PCT Filed: Nov. 9, 2006
(86) PCT No.: PCT/EP2006/068297

§ 371 Date: Sep. 15, 2008

Related U.S. Application Data
(60) Provisional application No. 60/736,061, filed on Nov. 10, 2005.

(51) Int. Cl. A01N 57/18

(52) U.S. Cl. 504/206

(57) ABSTRACT

The present invention relates to herbicidal compositions comprising aminophosphate or aminophosphonate salts, particularly to herbicidal compositions comprising an aminophosphate or aminophosphonate potassium salt. Preffered compositions of the invention have a high amount and the aminophosphate or aminophosphonate salt. The invention also relates to compositions of matter (or blend) that are especially useful ingredients for preparing the compositions comprising the aminophosphate or aminophosphonate salts.

### BACKGROUND OF THE INVENTION

The present invention relates to herbicidal compositions comprising aminophosphate or aminophosphonate salts, particularly to herbicidal compositions comprising an aminophosphate or aminophosphonate potassium salt. Preffered compositions of the invention have a high amount and the aminophosphate or aminophosphonate salt. The invention also relates to compositions of matter (or blend) that are especially useful ingredients for preparing the compositions comprising the aminophosphate or aminophosphonate salts.

Among various presentations of compositions comprising glyphosate, concentrated liquid compositions that can be diluted by the end-user (farmer) are of interest. Usually, the higher the glyphosate concentration is, the better it is, because the end-user can set the use concentration (amount of active applied to the field) by adjusting the dilution rate, and can avoid handling much product (the higher the concentration is, the lower the weight is for example).

Concentrated compositions can comprise a high amount of glyphosate, water, and at least one surfactant compound that can be useful as a formulation aid (dispersion, dissolution and/or stability of the glyphosate in water), and/or as a biological activator (for example increasing the efficacy the glyphosate, for example by encouraging wetting of a weed to be eliminated, or by encouraging penetration of the glyphosate into the weed). The amount of glyphosate, the surfactant(s), the amount thereof, and possible further ingredients might have also an effect onto the rheological properties of the formulation (for example viscosity, or ability to be spread), as such, or upon dilution. The rheological properties of the formulation as such or upon dilution are important for handling and spreading purpose.

Where the concentration of glyphosate is high, crystallization is to be avoided. Crystallization can occur at different temperatures, at different glyphosate concentrations, or when diluting with water. The crystallization is characterized by formation of small solid particles comprising glyphosate. These small particles can have the bad impact of filters clogging, nozzles clogging, creating unnecessary hazardous waste problems to dispose off the crystals, loss of activity (bioefficacy), and/or bad repartition of the active on the field.

Compositions comprising glyphosate and ethoxylated fatty amines surfactants are known. However these compounds are believed to be rather ecotoxic, irritant or slightly biodegradable. There is a need for replacing these compounds or for reducing the amount thereof in the compositions.

Compositions comprising aminophosphate or aminophosphonate isopropylamine, such as glyphosate isopropylamine salt (glyphosate IPA) are widely used. Examples of compositions on the market include composition having 360 g/L or 450 g/L of gyphosate IPA, as acid equivalent.

There is a need for new compositions that address at least one of the following:

lower cost, by using lower cost ingredients (the aminophosphate or aminophosphonate salts and/or the surfactants)

better ecotoxic profile (especially lowering amounts of fatty ethoxyltes such as fatty amine ethoxyles), and/or better perception of the ecotoxic profile,

easier use and/or or lower cost use, for example by allowing less packaging and/or less transportation means, for example by concentrating,

easier to handle, for example by having a favorable viscosity and/or by avoiding crystallization. (Crystallization can occur at different temperatures, at different glyphosate concentrations, or when diluting with water. The crystallization is characterized by formation of small solid particles comprising glyphosate. These small particles can have the bad impact of filters clogging, nozzles clogging, creating unnecessary hazardous waste problems to dispose off the crystals, loss of activity (bioefficacy), and/or bad repartition of the active on the field),

while keeping an acceptable efficacy or equivalent efficacy or even improving efficacy.

### BRIEF SUMMARY OF THE INVENTION

The invention addresses at least of the concerns above, or a combination thereof. Thus the invention relates to an aqueous herbicidal composition comprising:

at least 360 g/L of an aminophosphate or aminophosphinate potassium salt, preferably glyphosate potassium salt or glyphosinate potassium salt,

at least 80 g/L, preferably at least 100 g/L of an alkyl dimethyl amine oxide surfactant of formula (I) below:

R—N⁺(CH₃)₂—O—

wherein R is a linear or branched alkyl group having an average number of carbon atoms of from 8 to 30, and

optionally a solvent, preferably a polar solvent.

This invention also relates to a composition of matter (or “blend”) comprising:

optionally water, and

at least 50% by weight, preferably at least 75% by weight, preferably at least 90% by weight, of a mixture of the following compounds:
an alkyl dimethyl amine oxide surfactant of formula (I) below:

R—N⁺(CH₃)₂—O—
wherein R is a linear or branched alkyl group having an average number of carbon atoms of from 8 to 30, as described above, and
a solvent, preferably a polar solvent, as described above.

The composition of matter (blend) is especially suitable for the herbicidal compositions above, especially for those having a high concentration of the aminophosphate or aminophosphinate potassium salt. However it can be used in other compositions, including herbicidal compositions, for example in compositions having different aminophosphate or aminophosphinate salts, such as glyphosate IPA, glyphosate ammonium, or glyphosate sodium salts.

### DETAILED DESCRIPTION OF THE INVENTION

### Definitions

In the present specification, unless otherwise provided, the amounts of aminophosphate or aminophosphonate salt, preferably a glyphosate or gluphosinate salt salts are expressed as acid equivalents.

In the present specification, unless otherwise provided, the amounts of surfactants or compositions of matter are amounts “as is”, as opposed to amounts as active matter, dry amounts, or the like.

The ingredients of the composition are described below.

### Aminophosphate or Aminophosphonate Potassium Salt

Aminophosphate or aminophosphonate salts are known by the one skilled in the art. preferably a glyphosate or gluphosinate salt

Glyphosate refers to N-(phosphonomethyl)glycine.

Gluphosinate refers to 4-[hydroxy(methyl)phosphinoyl]-DL-homoalanine.

The salt is a potassium salt. Such salts are known by the skilled in the art. They can be prepared by adding potassium hydroxide to an acid form of the aminophosphate or aminophosphonate, for example to acidic glyphosate. This operation is often referred to as “neutralization”. In a particular embodiment the surfactant, or a part thereof, is also added during neutralization. This is believed providing higher stability of the compositions and/or allowing higher concentrations of the aminophosphate or aminophosphonate potassium salt.

In a preferred embodiment, the ratio between potassium and glyphosate is of about 1/1. However the ratio can of higher than 1/1. Such a ratio provides compositions having higher pH. The higher the pH, the lower the crystallization. pH can be also managed by using any other basic compounds, for example buffers.

### Alkyl Dimethyl Amine Oxide Surfactant

This surfactant has the following formula (I):

R—N⁺(CH₃)₂—O—
wherein R is a linear or branched alkyl group having an average number of carbon atoms of from 8 to 30, as described above.
   Such surfactanst are known, and are available on the market.

The R group is usually actually a mixture of different groups having different numbers of carbon atoms, being linear or branched, and optionally having some insaturations. These mixtures come from the reagents used to prepare them, which are actually distillation cuts and/or have a natural origin. In the present specification the number of carbon atoms in the R group refers to the number of carbon atoms of the two most represented species.

Preferably R has an average number of carbon atoms of from 10 to 18. Advantageously R is an alkyl group comprising at least 50% by weight of a lauryl or myristyl group, preferably a lauryl group.

### Solvent

The solvent is preferably a polar solvent.
The solvent is preferably water-miscible.
Useful solvent in herbicides formulations are known by the one skilled in the art.
For examples, the solvent can be:

a water-miscible glycol ether,

a water-miscible alcohol,

a water-miscible ketone

a water-miscible aldehyde

a water-miscible acetate.

Useful solvents include:

N-methyl-pyrrolidone (NMP, can be further identified for example with CAS number 872-50-4)

diester solvents,

propylene carbonate,

acetophenone,

ethylene glycol butyl ether,

diethylene glycol butyl ether,

methoxy methyl butanol,

propylene glycol methyl ether,

dipropylene glycol methyl ether,

gamma-butyrolactone,

dimethyl formamide (DMF),

furfuryl alcohol,

tetrahydrofuryl alcohol,

neopentyl glycol,

hexadiols,

hexylene glycol,

glycol ether amines,

ethylene glycol monoacetate, or

a mixture or association thereof.

Examples of diester solvents have the following formula:

R¹OOC-(CH₂)ₙ-COOR²,

wherein:

R¹ and R², identical or different, are C₁-C₁₀, preferably C₁-C₆, linear or branched, alkyl, aryl, alkaryl or arylalkyl groups, and

n is an average number of from 2 to 4.

The diester solvent can be a dialkyl, diaryl, dialkaryl or dialkylaryl adipate, such as for example diisobutyl adipate.

As n is an average number, the diester co-solvent can be a mixture of several compounds having different numbers of —CH₂- groups.
The diester solvent can be a mixture of adipate diesters (n=4), glutarate diesters (n=3), and succinate diesters (n=2).
The diester solvent is preferably a mixture of diisobutyl adipate, diisobutyl glutarate, and diisobutyl succinate, for example a mixture comprising:

from 59 to 67 parts by weight of diisobutyl glutarate,

from 20 to 28 parts by weight of diisobutyl succinate, and

from 9 to 7 parts by weight of diisobutyl adipate.

Examples of useful diester solvents include Rhodiasolv DIB®, marketed by Rhodia. The diester solvents described above are considered as green solvent having a low Volatile Organic Compound behavior and/or a low toxicity.
Other interesting diester solvents include dimethyl adipate and mixutres of dimethyl adipate, dimethyl glutarate and dimethyl succinate, for example Rhodiasolve RPDE®, marketed by Rhodia.

### Further Ingredients

The herbicidal composition can comprise further ingredients, such as:

surfactants different from the alkyldimethylamine oxide,

anti-foaming agents,

solvents, preferably water miscible solvent, preferably polar solvents, or

deposition control agents such as anti-rebound or anti-drift agents, optionally added afterward.

In a particular embodiment the composition is substantially free (less than 10% by weight of the total composition, preferably less than 1%, preferably none) of a humectant selected from polyhydric alcohols, polysaccharide humectants, and mixtures thereof.

The one skilled in the art knows further ingredients that can be used for managing some properties or features of the composition and/or for adding benefits.

The formulations can for example comprise for example:

organopolysiloxanes antifoaming agent;

thickening agents such as xanthan gum type polysaccharides, alginates, carboxylated or hydroxylated methylcelluloses, synthetic macromolecules of the polyacrylate, polymaleate, polyvinylpyrrolidone, polyethylene glycol or polyvinyl alcohol type, or of the inorganic type such as bentonites.

auxiliary additives such as antioxidants, anti-UV agents, colorants, etc.

solvent such as an alcohol, for example isopropanol, typically up to 15% by weight.

The amount of these additives listed above is normally less than 10% by weight, preferably 1% by weight or less, advantageously 0.1% by weight or less compared with the composition weight.

### Other Surfactants

The herbicidal composition can comprise a further surfactant, different from the betaine of the surfactant composition matter. This further surfactant can provide further advantages or synergies in term of costs, and/or bioefficacy, and/or rheology management, and/or environment concerns.

Examples of further surfactants include:

an ethoxylated fatty amine, a fatty amine,

an ether carboxylate,

an acid or non acid mono- and di-ester phosphate, optionally polyalkoxylated,

an alkylmonoglycoside or alkylpolyglycoside, advantageously octylglycoside, an octylpolyclycoside, decylglycoside, a decylpolyglycoside, or a mixture thereof

bétaines (alkyldimethylbétaines, or alkylamidoalkyldimethylbetaines, such as alkylamidopropyldimethylbetaines, where the alkyl is R group as describes above), or

mixtures thereof.

In a particular embodiment, the composition is substantially free (less than 10% by weight of the total surfactant amount, preferably less than 1%, preferably none) of bétaines.

The fatty amines or ethoxylated fatty amines can comprise at least one hydrocarbon group containing 2 to 24 carbon atoms, optionally polyalkoxylated.

The fatty amines or ethoxylated fatty amines can more particularly be selected from amines comprising at least one linear or branched, saturated or unsaturated group containing 2 to 24 carbon atoms, preferably 8 to 18 carbon atoms, optionally comprising 2 to 30 oxyethylene groups, or a mixture of a plurality thereof. Examples include ethoxylated tallow amines.

The fatty amines or ethoxylated fatty amines can be selected from ethoxylated fatty amines comprising at least one linear or branched, saturated or unsaturated groups containing 6 to 24 carbon atoms, preferably 8 to 20 carbon atoms, comprising 2 to 30 oxyethylene groups, or a mixture of a plurality thereof. Examples include the compounds having the following formula:

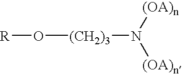

wherein R represents a linear or branched, saturated or unsaturated hydrocarbon group containing 6 to 24 carbon atoms, preferably 8 to 20 carbon atoms; 1 0 OA represents an oxypropylene group; and n, n′, which may or may not be identical, OA represent a mean number in the range 1 to 30.

Examples of such amines that can be cited are amines derived from copra and containing 5 oxyethylene (OE) motifs, oleic amines containing 5 OE, amines derived from tallow containing 5-20 OE, for example 10, compounds corresponding to the above formula, in which R is an alkyl group containing 12 to 15 carbon atoms, the number of OE motifs being in the range 20 to 30.

The amount of fatty amines or ethoxylated fatty amines can be of from 0 (none) to 120 g/l of the composition, preferably of from 0 (none) to 60 g/l.

The ether carboxylate has preferably formula R(OCH₂CH₂)ₙOCH₂CO₂⁻, wherein R is a linear or branched alkyl, alkenyl, alkylphenyl or polypropyleneoxy group having from 6 to 20, for example 8 to 14, aliphatic carbon atoms and n is of from 1 to 30, preferably of from 2 to 20. The ether carboxylate has preferably a counter ion being ammonium or potassium, or obtained from an amine or alkanolamine having up to 6 carbon atoms.

The acid or non acid mono- and di-ester phosphate optionally polvalkoxylated is selected from acid or non acid phosphate mono- or di-esters, optionally polyalkoxylated, with the formula below:

(AO)₃₋ₘP(=O)(OM)ₘ

wherein:

A, identical or different, represents a group R′¹—O(CH₂-CHR′²—O)ₙ wherein:
R′¹, identical or different, represents a linear or non linear, saturated or unsaturated C₆-C₂₀ hydrocarbon group, preferably C₈-C₁₈;
R′², identical or different, represents a hydrogen atom or a methyl or ethyl group, preferably a hydrogen atom;
n is a mean number of motifs in the range 0 to 10, preferably in the range 2 to 10;
M, identical or different, represents a hydrogen atom, an alkali or alkaline-earth metal, a N(R³)₄⁺ type radical wherein R³, identical or different, represents a hydrogen atom or a linear or non linear, saturated or unsaturated C₁-C₆ hydrocarbon group optionally substituted with a hydroxyl group;
m is a whole or average number in the range 1 to 2.

The acid or non acid mono- and di-ester phosphate, optionally polyalkoxylated can be in the form of a monoester, a diester, or a mixture of these two esters.

The amount of acid or non acid mono- and di-ester phosphate, optionally polyalkoxylated can be of from 0 (none) to 120 g/l of the composition.

### Composition of Matter (Blend)

The composition of matter (or “blend”) comprises:

optionally water, and

at least 50% by weight, preferably at least 75% by weight, preferably at least 90% by weight, of a mixture of the following compounds:
an alkyl dimethyl amine oxide surfactant of formula (I) below:

R—N⁺(CH₃)₂—O
wherein R is a linear or branched alkyl group having an average number of carbon atoms of from 8 to 30, as described above, and
a solvent, preferably a polar solvent, as described above.

Preferably, the ratio by weight between the solvent and the alkyl dimethyl amine oxide surfactant is of from 0.025 to 0.20, preferably from 0.05 to 0.15, preferably from 0.08, to 0.1.

The composition of matter can also comprise one or several of the further ingredients above, especially an anti-foaming agent.

### Process for Preparing the Herbicidal Composition.

The compositions of the invention can be prepared by mixing their different constituents with moderate stirring.

This operation preferably takes place at a temperature in the range 15° C. to 60° C., preferably at a temperature close to ambient temperature (15-30° C.).

The surfactant is preferably only added once the other constituents have been mixed. Alternatively the surfactant or a part thereof is added during neutralization of the aminophophate or aminophosphonate. The remaining part can be added afterwards.

### Composition: Concentrations and Other Parameters

In one embodiment the composition comprises the solvent. In this embodiment the composition advantageously comprises from 1 g/L to 50 g/L of the solvent, preferably from 5 g/L to 25 g/L of the solvent, preferably from 10 g/L to 20 g/L of the solvent.

In a preferred embodiment the composition has:

aminophosphate or aminophosphinate potassium salt being glyphosate potassium salt, and

N-methyl-pyrrolidone solvent.

Advantageously the composition comprises:

from 400 to 500 g/L of glyphosate potassium salt, and

from to 100 to 140 g/L, preferably from 100 to 120 g/L of the alkyl dimethyl amine oxide surfactant.

More advantageously, the composition comprises:

at least 500 g/L of glyphosate potassium salt, from 100 to 160 g/L, preferably from 120 to 150 g/L of the alkyl dimethyl amine oxide surfactant, and

from 1 to 50 g/L of the solvent, preferably from 5 to 25, preferably from 10 to 20 g/L.

Preferably, especially at high potassium glyphosate loads, the composition comprises the solvent, and the ratio by weight between the solvent and the alkyl dimethyl amine oxide surfactant is of from 0.025 to 0.20, preferably from 0.05 to 0.15, preferably from 0.08, to 0.1.

In a preferred embodiment the composition does not form anisotropic aggregates and/or liquid crystals after application on foliage. In a preferred embodiment the composition does not form transcuticular channels in leaves and/or epicuticular channels on leaves. In those embodiment efficacy remain surprisingly high.

In an embodiment the composition has a viscosity of lower than 250 cP at 0° C. at 45 s⁻¹ shear rate. In an embodiment the composition has a viscosity of lower than 250 cP at 35° C. with a Brookfield RTV viscosimeter, spindle 4 and/or 2, at 50 rpm and/or 20 rpm. In an embodiment the composition has a viscosity of lower than 250 cP at 25° C. and/or 26° C. with a Brookfield RTV viscosimeter, spindle 4 and/or 2, at 50 rpm and/or 20 rpm. These can be realized for compositions comprising at least 530 g/L glyphosate potassium salt.

In an embodiment the composition has a viscosity of higher than 250 cP at 0° C. at 45 s⁻¹ shear rate, for example higher than 1000 cP. In an embodiment the composition has a viscosity of higher than 250 cP, for example higher than 1000 cP at 0° C. with a Brookfield RTV viscosimeter, spindle 4 and/or 2, at 50 rpm and/or 20 rpm. In an embodiment the composition has a viscosity of higher than 250 cP, for example higher than 1000 cP, at 25° C. and/or 26° C. with a Brookfield RTV viscosimeter, spindle 4 and/or 2, at 50 rpm and/or 20 rpm. These can be realized for compositions comprising at least 530 g/L glyphosate potassium salt.

### Downstream Use

The herbicidal composition of the invention can be thus used to treat plants, normally after diluting with water. The diluted composition can be applied onto a field by any appropriate mean.

The dilution, and the application onto the field, can be for example such that the amount of aminophosphate or amoniphosphonate potassium salt, preferably glyphosate potassium salt, is of from 500 g acid equivalent/ha to 1500 g acid equivalent/ha, typically from 600 to 1200 g/ha.

Some details or advantages of the invention will appear in the non-imitative examples below.

### EXAMPLES

### Examples 1-7

The compositions in Table I below are prepared are prepared (C stands for comparative, ae stands for acid equivalent).

Samples of 50 mL each are prepared in volume flasks, individually neutralized. Tap water is used.

TABLE I

| | 1 | 2 | 3 | 4 | 5 | 6 | 7 |
|---|---|---|---|---|---|---|---|
| Glyphosate Potassium⁴⁾ | 540ae | 540ae | 540ae | 540ae | 540ae | 540ae | 540ae |
| (g/L) | | | | | | | |
| Surfactant 1¹⁾ (g/L) | 150 | 150 | 150 | 115 | 115 | 115 | 115 |
| NMP³⁾ (g/L) | 14 | 12 | 10 | 14 | 12 | 10 | — |
| Water | To volume | | | | | | |
| Specific Gravity (20° C.) | 1.363 | 1.364 | 1.363 | 1.364 | 1.365 | 1.364 | 1.363 |
| pH (7% in D.I. water) | 4.70 | 4.72 | 4.70 | 4.70 | 4.69 | 4.70 | 4.68 |
| Viscosity²⁾ 20 rpm | 100 | 150 | 240 | 50 | 80 | 100 | 2680 |
| | | | | | | | High visco |
| Viscosity²⁾ 50 rpm | 120 | 160 | 244 | 70 | 90 | 120 | 2440 |
| | | | | | | | high visco |
| Initial colour | Almost | Almost | Almost | Almost | Almost | Almost | Almost |
| | colourless | colourless | colourless | colourless | colourless | colourless | colourless |
| Colour after 12 weeks at | Almost | Almost | Almost | Almost | Almost | Almost | Almost |
| 54° C. | colourless | colourless | colourless | colourless | colourless | colourless | colourless |
| Stability after 3 days at | Stable | Stable | Stable | Stable | Stable | Stable | Stable |
| 54° C. and 3 days at 0° C. | | | | | | | |
| Stability after 3 weeks at | Stable | Stable | Stable | Stable | Stable | Stable | Stable |
| 54° C. | | | | | | | |

¹⁾Lauryldimethylamine oxide
²⁾Brookfield RVT, 26° C., spindle 4, 50 mL sample, expressed as cP, measured on 50 mL in a 60 mL glass of inner diameter of about 3.5 cm.
³⁾M-pyrol Micropure Ultra II, ISP technologies
⁴⁾Provided as 568.6 g/L mixture of Glyphosate 95% acid (white powder) and KOH 50.32%

### Examples 8

The composition below is prepared

| | 8 |
|---|---|
| Glyphosate Potassium⁴⁾ (g/L) | 540ae |
| Surfactant 1¹⁾ (g/L) | 146 |
| NMP³⁾ (g/L) | 14 |
| Water | To volume |

¹⁾Lauryldimethylamine oxide
³⁾M-pyrol Micropure Ultra II, ISP technologies
⁴⁾Provided as a 678 g/L mixture of Glyphosate 95% acid (white powder) and KOH 50.32%

Viscosity at different temperatures is measured (Brookfield RVT, spindle 2, 20 rpm):

| Temperature | Viscosity. (cP) |
|---|---|
| 0° C. | 207.5 |
| 5° C. | 175.0 |
| 10° C. | 145.0 |
| 15° C. | 126.0 |
| 20° C. | 101.5 |
| 25° C. | 92.0 |

### Examples 9-14

The composition in Table II below are prepared or used (C stands for comparative, ae stands for acid equivalent).

TABLE II

| | 9C (SD33A) | | 11C (SD41A) | 12 (SD41D) | 13 (SD41E) | |
|---|---|---|---|---|---|---|
| | (AP5-05-98A) | 10C | (AP5-05-115A) | (AP5-05-113A) | (AP5-05-113B) | 14C |
| Glyphosate Potassium⁴⁾ | | Roundup ® | | 450 | 540 | Roundup ® |
| (g/L) | | CT, | | | | Powermax, |
| Glyphosate IPA⁵⁾ (g/L) | 450 | Monsanto | 510 | | | Monsanto |
| Surfactant 1¹⁾ (g/L) | | | | 120 | 105 | |
| Surfactant 2⁶⁾ (g/L) | 120 | | 140 | | | |
| NMP³⁾ (g/L) | | | | 10 | 10 | |
| Water | To volume | | | | | |

¹⁾Lauryldimethylamine oxide
³⁾M-pyrol Micropure Ultra II, ISP technologies
⁴⁾Provided as 611 g/L mixture of Glyphosate 95% acid (white powder) and KOH 50.32%
⁵⁾Glyphosate IsoPropylAmine, provided as a 639.4 g/L concentrate
⁶⁾Geronol CF/AS HL, Rhodia

### Tests

The activities of the compositions (“formulations”) are compared when applied (by spraying) to annual ryegrass and canola.
Application Rate: Formulations applied at 35, 70 & 140 g ai/ha.
Test species: Annual ryegrass (Lolium rigidum); Canola (Brassica napus var. rainbow)
Days to spray: Canola: 18; Annual ryegrass: 22
Days from spray to assessment: 14*

### Materials and Methods:

### Plant Propagation

Annual ryegrass and canola seeds (5/pot) are sown at 2 mm depth in 10 cm diameter pots filled with potting mix (AS 3743) that have been amended with macro and micronutrients to ensure optimal growth. One week after seedling emergence, seedlings are thinned for uniform size to one seedling per pot. Canola are grown in a temperature-controlled greenhouse (14° C.-25° C.) for 8 days then outdoors for 10 days prior to spray application. Annual ryegrass are grown in a temperature-controlled greenhouse (14° C.-25° C.) for 12 days then outdoors for 10 days prior to spray application. After the application of herbicides the pots are returned to the greenhouse until plants are assessed for fresh weight.

### Herbicide Application

Herbicide formulations are applied using an enclosed laboratory track-sprayer fitted with three 110° flat fan nozzles (Teejet XR11001-VS) spaced at 50 cm intervals across the boom. The boom moves along a fixed track at 6 km h⁻¹, sprayed at a water volume of 64 L ha⁻¹ with a pressure of 200 kPa.

### Assessment

Seedlings are harvested 14DAT by cutting foliage off at base immediately prior to weighing on an AND FX 300 electronic balance (range 0-300 g).

### Statistical Analysis

Data is analysed using a factorial design with two factors, Formulation and Rate. 95% least significant differences (LSD) are calculated for the mean of each treatment. The lowest fresh weight (ie. greatest herbicidal effect) is denoted with alpha code “a” when significantly different to other treatments, which are coded “b”, “c”, “d” etc. with increasing fresh weight.

### Environmental Conditions

Temperature within the greenhouse is recorded at 9AM, 12PM and 5PM daily following application of herbicides.

| | Temperature ° C. | | |
|---|---|---|---|
| Date | 9 AM | 12 PM | 5 PM |
| Day 1 | 21 | 26 | 23 |
| Day 2 | | | |
| Day 3 | | | |
| Day 4 | 24 | 28 | 28 |
| Day 5 | 20 | 24 | 21 |
| Day 6 | 18 | 25 | 22 |
| Day 7 | 20 | 25 | 23 |
| Day 8 | 21 | 24 | 23 |
| Day 9 | | | |
| Day 10 | | | |
| Day 11 | 20 | 25 | 22 |
| Day 12 | 21 | 24 | 22 |
| Day 13 | 22 | 24 | 21 |
| Day 14 | 20 | 23 | 22 |
| Day 15 | 17 | 22 | 21 |

### Results on Canola (Formulation×Rate), for Glyphosate 450 q/L Compositions

All formulations are bioequivalent at 140 & 70 g ai/ha (Table 3). Example 10C (Roundup® CT) and Example 12 (SD41D) are more efficacious at 35 g ai/ha than Example 9C (SD33A).

TABLE 1
FAOV Table & significant differences Fresh weight
(g) 14DAT-Canola-450 g/L formulations

| | Rate (g ai/ha) | | | |
|---|---|---|---|---|
| | 35 | 70 | 140 | Formulation Mean |
| UTC | 5.87 | | | |
| 10C (Roundup CT) | 1.72 b | 0.69 a | 0.55 a | 0.99 a |
| 9C (SD33A) | 2.39 c | 0.76 a | 0.50 a | 1.22 ab |
| 12 (SD41D) | 1.68 b | 0.84 a | 0.41 a | 0.98 a |
| Rate Mean | 2.09 c | 0.77 b | 0.48 a | |

### Results on Annual Ryegrass (Formulation×Rate) for Glyphosate 450 g/L Compositions

Example 12 (SD41 D) is bioequivalent to Example 10C (Roundup® CT).

TABLE 4
FAOV Table & significant differences Fresh weight
(g) 14DAT-Annual ryegrass-450 g/L formulations

| | Rate (g ai/ha) | | | |
|---|---|---|---|---|
| | 35 | 70 | 140 | Formulation Mean |
| UTC | 0.36 | | | |
| 10C (Roundup CT) | 0.20 | 0.12 | 0.03 | 0.12 a |
| 9C (SD33A) | 0.27 | 0.19 | 0.05 | 0.17 b |
| 11C (SD41D) | 0.22 | 0.09 | 0.04 | 0.12 a |
| Rate Mean | 0.22 c | 0.12 b | 0.04 a | |

### Results on Canola (Formulation×Rate) for Glyphosate 510 or 540 g/L Compositions

All treatments at 70 & 140 g ai/ha are bioequivalent (Table 5).

TABLE 5
FAOV Table & significant differences Fresh weight
(g) 14DAT-Canola-510 & 540 g/L formulations

| | Rate (g ai/ha) | | | |
|---|---|---|---|---|
| | 35 | 70 | 140 | Formulation Mean |
| UTC | 5.87 | | | |
| 14C (Roundup | 1.18 bc | 0.46 a | 0.53 a | 0.72 a |
| PowerMAX) | | | | |
| 11C (SD41A) | 1.93 d | 0.59 a | 0.53 a | 1.02 bc |
| 13 (SD41E) | 2.01 d | 0.84 ab | 0.52 a | 1.12 c |
| Rate Mean | 1.67 b | 0.65 a | 0.50 a | |

### Results on Annual Ryegrass (Formulation×Rate), for Glyphosate 510 or 540 g/L Compositions

There is no significant difference between any formulation at 140 g ai/ha (Table 9). Example 14C (Roundup PowerMAX) is bioequivalent to Example 13 (SD41E) at 35 g ai/ha.

TABLE 6
FAOV Table & significant differences Fresh weight (g)
14DAT-Annual ryegrass-510 & 540 g/L formulations

| | Rate (g ai/ha) | | | |
|---|---|---|---|---|
| | 35 | 70 | 140 | Formulation Mean |
| UTC | 0.36 | | | |
| 14C (Roundup | 0.12 bcd | 0.08 ab | 0.07 ab | 0.09 a |
| PowerMAX) | | | | |
| 11C (SD41A) | 0.20 e | 0.16 cde | 0.05 ab | 0.14 b |
| 13 (SD41E) | 0.18 de | 0.19 de | 0.05 ab | 0.14 b |
| Rate Mean | 0.20 c | 0.13 b | 0.06 a | |

1-12. (canceled)

13. An aqueous herbicidal composition comprising:
at least 360 g/L of an aminophosphate or aminophosphinate potassium salt,
at least 80 g/L of an alkyl dimethyl amine oxide surfactant of the formula:
R—N⁺(CH₃)₂—O—
wherein R is a linear or branched alkyl group having an average number of carbon atoms ranging from 8 to 30 carbon atoms, and
optionally a solvent.

14. The composition of claim 13, wherein the aminophosphate or aminophosphinate salt is glyphosate potassium salt or glyphosinate potassium salt.

15. The composition of claim 13, wherein the solvent is a polar solvent.

16. The composition of claim 13, wherein the solvent is present in an amount ranging from 1 g/L to 50 g/L.

17. The composition of claim 13, wherein the solvent is present in an amount ranging from 5 g/L to 25 g/L.

18. The composition of claim 13, wherein the solvent is present in an amount ranging from 10 g/L to 20 g/L.

19. The composition of claim 13, wherein the solvent is:
N-methyl-pyrrolidone (NMP),
a diester solvent,
propylene carbonate,—acetophenone,
ethylene glycol butyl ether,
diethylene glycol butyl ether,
methoxy methyl butanol,
propylene glycol methyl ether,
dipropylene glycol methyl ether,
gamma-butyrolactone,
dimethyl formamide (DMF),
furfuryl alcohol,
tetrahydrofuryl alcohol,
neopentyl glycol,
hexadiols,
hexylene glycol,
glycol ether amines,
ethylene glycol monoacetate, or
a mixture or association thereof

20. The composition of claim 13, wherein:
the aminophosphate or aminophosphinate potassium salt is glyphosate potassium salt, and
the solvent comprises N-methyl-pyrrolidone.

21. The composition of claim 13, wherein R has an average number of carbon atoms ranging from 10 to 18 carbon atoms.

22. The composition of claim 13, wherein R is an alkyl group comprising at least 50% by weight of a lauryl group.

23. The composition of claim 13, wherein R is an alkyl group comprising at least 50% by weight of a myristyl group.

24. The composition of claim 13, comprising:
an amount of glyphosate potassium salt ranging from 400 to 500 g/L, and
an amount of alkyl dimethyl amine oxide surfactant ranging from 100 to 140 g/L.

25. The composition of claim 13, comprising:
at least 500 g/L of glyphosate potassium salt,
an amount of alkyl dimethyl amine oxide surfactant ranging from 100 to 160 g/L, and
an amount of the solvent ranging from 1 to 50 g/L.

26. The composition of claim 25, wherein the amount of alkyl dimethyl amine oxide surfactant ranges from 120 to 150 g/L.

27. The composition of claim 25, wherein the amount of the solvent ranges from 5 to 25 g/L.

28. The composition of claim 27, wherein the amount of the solvent ranges from 10 to 20 g/L.

29. The composition of claim 13, wherein the ratio by weight of the solvent to the alkyl dimethyl amine oxide surfactant ranges from 0.025 to 0.20.

30. The composition of claim 29, wherein the ratio by weight of the solvent to the alkyl dimethyl amine oxide surfactant ranges from 0.05 to 0.15.

31. The composition of claim 29, wherein the ratio by weight of the solvent to the alkyl dimethyl amine oxide surfactant ranges from 0.08 to 0.1.

32. The composition of claim 13, further comprising:
at least one surfactant different from the alkyl dimethyl amine oxide surfactant,
at least one anti-foaming agent,
at least one deposition control agent, optionally added afterward, or
mixtures or associations thereof.

33. The composition of claim 32, wherein the at least one deposition control agent is at least one anti-rebound or anti-drift agent.

34. A composition of matter comprising:
optionally water, and
at least 50% by weight of a mixture of the following:
an alkyl dimethyl amine oxide surfactant of the formula:
R—N⁺(CH₃)₂—O—
wherein R is a linear or branched alkyl group having an average number of carbon atoms ranging from 8 to 30 carbon atoms, and
a solvent.

35. The composition of claim 34, wherein the solvent is a polar solvent.

36. The composition of matter of claim 34, wherein the amount of the mixture is at least 75% by weight of the composition.

37. The composition of matter of claim 36, wherein the amount of the mixture is at least 90% by weight of the composition.

38. The composition of matter of claim 34, wherein the ratio by weight between the solvent and the alkyl dimethyl amine oxide surfactant ranges from 0.025 to 0.20.

39. The composition of matter of claim 34, wherein the ratio by weight between the solvent and the alkyl dimethyl amine oxide surfactant ranges from 0.05 to 0.15.

40. The composition of matter of claim 34, wherein the ratio by weight between the solvent and the alkyl dimethyl amine oxide surfactant ranges from 0.08 to 0. 1.
